(19) United States
(12) Patent Application Publication
(10) Pub. No.: US 2002/0181668 A1
(43) Pub. Date: Dec. 5, 2002

(54) Method and system for radio frequency/fiber optic antenna interface

(76) Inventors: Lee Masoian, West New York, NJ (US); Frank S. Barbara, Scarsdale, NY (US)

Correspondence Address: LEE MASOIAN, AEROCOMM, INC, 464 HUDSON TERRACE, ENGLEWOOD CLIFFS, NJ, 07632, US

(21) Appl. No.: 09/872,707

(22) Filed: Jun. 1, 2001

(51) Int. Cl. H04B 10/00

(52) U.S. Cl. 379/56.3; 455/426

(57) ABSTRACT

An antenna system for use with cellular and other radio frequency communications is disclosed. The system includes an antenna for receiving radio frequency transmissions as well as an interface box for converting radio frequency signals to fiber optic signals. The fiber optic signals are then transmited along fiber optic cables, eliminating the need for heavy coaxial cables. The fiber optic signal is converted to a radio frequency signal by a converter. Then, a communication base station receives the radio frequency signal from the converter and transmits that signal.

### FIELD OF INVENTION

This invention relates to the field of communications, and more specifically, to a radio frequency/fiber optic antenna interface.

### BACKGROUND OF INVENTION

The increased use of wireless communications, such as cellular phones, pagers, wireless broadband communications, etc. has lead to the proliferation of antennas and antenna systems to relay the communication from one point to another. These antennas are typically mounted on a tower, on top of a tall building in the case of a downtown area, or on specially constructed structures. No matter how the antennas are mounted, current application systems receive radio frequency communication and then send the communication signals over a coaxial cable to either a new base station to retransmit the communication signals or to a new systems of antennas for retransmission. The problem is the coaxial cables that are required to be attached to the antennas can be very large. Also, there can be a large number of cables attached to an antenna to handle large amounts of communication traffic. The size and amount of coaxial cables can be a problem antenna towers or other structures, which cannot support the weight of coaxial cables needed for antennas to provide services. Additionally, routing coaxial cables in buildings and other structures is difficult because coaxial cables do not bend well and are generally large and bulky.

Fiber optics is a way to transmit communications using a thin glass cable and a laser. A fiber optic cable can transfer more channels of communications than a coaxial cable for a given cable size and is much thinner and lighter. Therefore, what is needed is a way to attach the output of an antenna to a fiber optic cable in order to provide for a lighter cabling, as well as cable that is more flexible.

### SUMMARY OF THE INVENTION

In accordance with the teachings of the present inventions, method and system for radio frequency/fiber optic interface is given.

In one embodiment, an antenna system is disclosed. The system includes an antenna for receiving radio frequency transmissions. Coupled to the antenna is an interface box that converts the radio frequency signal to fiber optic signals. The signal is the sent over a run of fiber optic cable to a remote fiber optic converter which will convert the signal back to a radio frequency signal for further broadcasting.

The disclosed system has several technical advantages over current systems. By using fiber optic cabling, heavy coaxial cable is avoided. This saves on weight and cost. Also coaxial cable is not as flexible as fiber optics. Other technical advantages are evident from the following discussion and claims.

### BRIEF DESCRIPTION OF THE DRAWINGS

For a more complete understanding of the present invention and advantages thereof, reference is now made to the following descriptions, taken in conjunction with the following drawings, in which like reference numerals represent like parts, and in which:

FIG. 1 is a schematic drawing of an antenna system utilizing a radio frequency/fiber optic antenna interface;

FIG. 2 is a schematic detailed diagram of an external antenna with a fiber optic interface; and

FIG. 3 is a schematic diagram of an integrated fiber optic antenna.

### DETAILED DESCRIPTION OF THE DRAWINGS

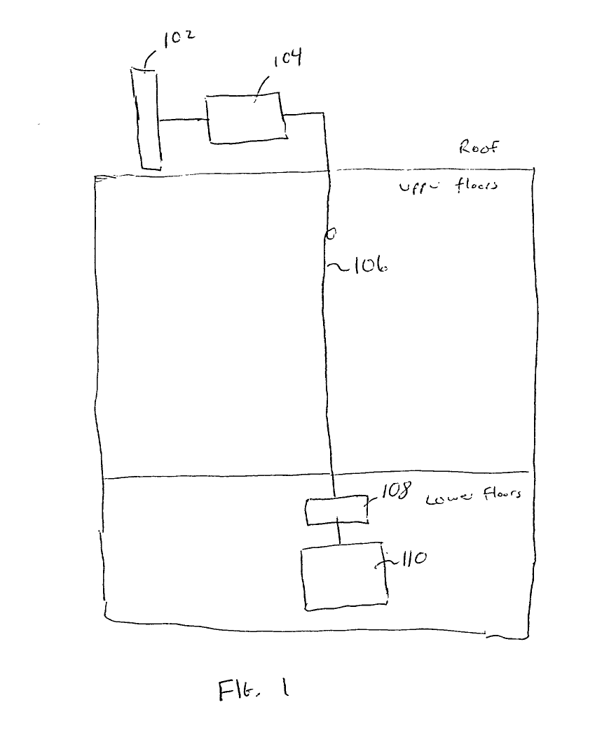

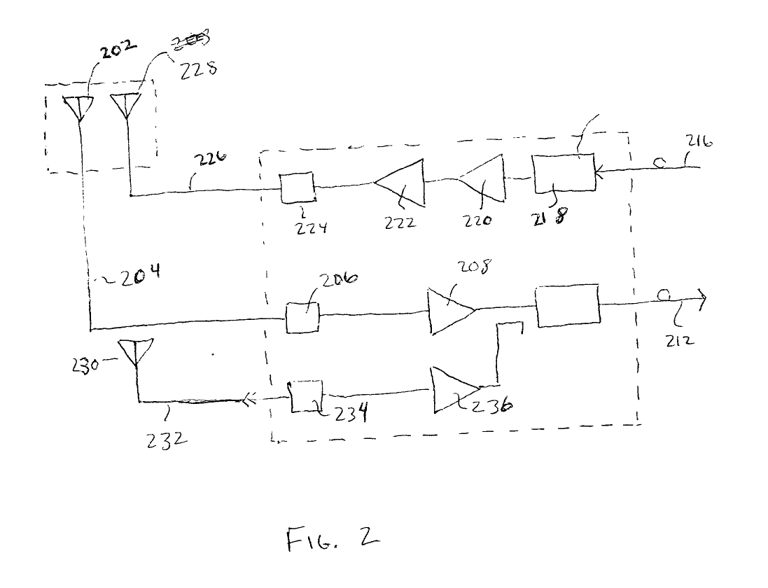

FIG. 1 is a schematic diagram of an antenna-based station system 100. Illustrated is an antenna 102 coupled to a fiber optic interface box 104. Fiber optic interface box 104 is coupled via a length of fiber optic cable to a fiber optic RF converter 108, which in turn is coupled to a base station.

Antenna 102 can be any one of a number of antennas operable to receive a radio frequency signal in any of a variety of frequencies. For example, antenna 102 may be a panel antenna operating in a cellular frequency range such as 900 MHz or 1.9 GHz. Also, antenna 102 could be a yagi antenna, a directional antenna or a parabolic grid antenna, which is also a directional antenna that can operate in a number of frequency ranges depending upon the exact design of the antenna or a radio frequency antenna. Therefore, the exact design or type of antenna is unimportant, as long as the antenna is operable to receive a radio frequency signal and send it to an output.

Fiber optic antenna interface box 104 is operable to receive a radio frequency signal from antenna 102 and converted it into an optical signal for transmission over a fiber optic cable. Typically, the connection between the antenna and the fiber optic antenna interface box 104 is via a run of coaxial cable. However, in one embodiment, the antenna interface box 104 can be integrated as a single unit combined with antenna 102. Fiber optic antenna interface box 104 is operable to receive a signal from antenna 102, amplify that signal, convert that signal into a optical signal and then to propagate along a line of fiber optic cable. Additionally, fiber optic interface box is operable to receive an optical signal that is representative of a radio frequency signal received, convert that back to a radio frequency signal within the fiber optic antenna interface box, and then amplify that radio frequency signal for broadcast over antenna 102. Thus, fiber optic antenna interface box 104 is used for both up-link and downlink communication.

Fiber optic RF converter 108 is operable to receive a fiber optic signal from fiber optic antenna interface box 104 and convert that back to a radio frequency signal for presentation to a base station 110 or other means of broadcasting the signal. Also, RF converter 108 is operable to receive a RF signal from a base station and convert that signal to an optical signal for presentation to fiber optic antenna interface box 104, which, in turn, will present it to antenna 102 for broadcast.

Base station 110 is, in one embodiment, a cellular communication base station. If base station 110 is a cellular-based station, it can be used to provide communication for any number of cellular telephone subscribers. In place of a cellular base station 110, a series of rebroadcast antennas might be added. This embodiment is particularly useful inside of large building, where a number of antennas can be set on each floor in order to both receive communications from within a building and transmit them outside of the building and to receive communications from outside of the building and transmit it to the users inside of the building.

In operation, a radio frequency signal is received by antenna 102. That signal is transmitted either over a short distance by a coaxial cable to fiber optic antenna interface box 104 or, if the fiber optic antenna interface box 104 is integrated with the antenna, the signal is immediately received by the fiber optic antenna interface box 104. Then, fiber optic antenna interface box 104 converts the radio frequency signal to an optical signal. The optical signal is then transmitted along a length of fiber optic cable 106. The advantage of using fiber optic 106 cabling to replace coaxial cabling between the antenna is that the coaxial cable is much larger than the fiber optic cable 106 for the same given number of transmission signals. Communication signals in the fiber optic cabling 106 is received by a fiber optic to radio frequency converter 108, which will convert the fiber optic signal back to a radio frequency signal for presentation to a base station 110. Base station 110 will then broadcast the received signal for reception by users of wireless communication.

Also, the system 100 can be used in an up-link fashion. In that case, a signal is received by base station 110. This signal will be radio frequency signal, from, for example, a cellular phone user. The signal is then presented to radio frequency fiber optic converter 108, where it is converted to an optical signal and transmitted along fiber optic cable 106. Fiber optic antenna interface box 104 receives the fiber optic signal in fiber optic cable 106 and converts the signal back to a radio frequency signal. The radio frequency signal is then amplified and presented to antenna 102 for further broadcast.

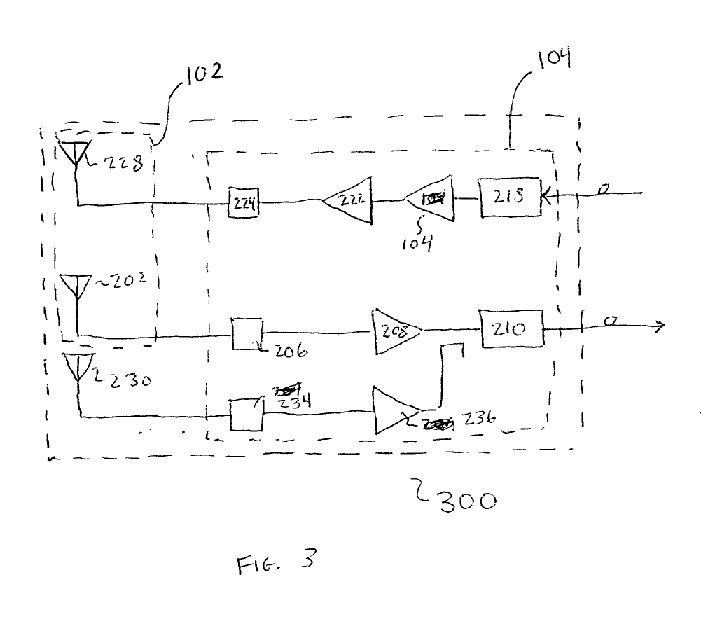

FIG. 2 illustrates an external antenna fiber optic schematic drawing. Illustrated is fiber optic interface box 104 coupled to a series of antennas 102. The external antennas comprise both a up-link antenna 202 and a downlink antenna 228. Concerning first the up-link side, up-link antenna 202 is coupled by a coaxial cable 204 to a band pass filter 206, which will isolate the communication band of interest. Coupled to band pass filter 206 is the input to a low noise amplifier 208, which amplifies the signal from the band pass filter 206. The output of the low noise amplifier 208 is then sent to a fiber optic radio frequency converter 210, which will convert the signal from a radio frequency signal to a fiber optic signal and then transmit that signal along fiber optic cable 212.

Considering the downlink side, fiber optic cable 216 is carrying a communications signal from a base station or other device. The signal from the fiber optic cable 216 is provided as an input to a fiber optic to radio frequency converter 218, where the signal is converted to a radio frequency signal. The output of the fiber optic to radio frequency converter is a radio frequency signal that is received by an intermediate amplifier 220, which in turn drives a power amplifier 222. The purpose of the amplifiers is to increase the gain and the power of the signal sufficient for broadcasting. The output of the power amplifier 222 is then provided to a band pass filter 224, which will pass the communication signal frequency of interest. The signal is then sent to antenna 228 via a coaxial cable 226 for broadcast.

Again, external antenna 202 can be any number of different types of radio frequency antennas. Coaxial cable 204 is standard, a coaxial cable and band pass filter 206 is a standard band pass filter where the band pass of interest is depends upon the communication band of interest. For example, in typical cellular communication, the band pass filter may be a 900 MHz filter. Low noise amplifier 208 amplifies the signal, also subjecting the signal to minimum spurious noise. Fiber optic to RF converter 210 converts the fiber optic signal to a radio frequency signal and is available commercially from a number of vendors.

Fiber optic to RF converter 218 is as before, a fiber optic converter of well known design. Intermediate amplifier 220 amplifies the output of the fiber optic to RF converter 218 to an intermediate level for input to a power amplifier 220. The purpose of these two amplifiers is to amplify the signal to a sufficient level for broadcast via antenna 228. Band pass filter 224 is again a band pass filter designed to transmit the band of concern. The pass band will thus depend on the frequency that is being used. A coaxial cable connects the band pass filter to the antenna 228.

In this case, the fiber optic interface box 104 is connected to the antennas 222 and 228 via coaxial cables 224 and 226. This configuration can be used in existing systems where the fiber optic interface box 104 can be incorporated into existing antenna schemes and while saving a large cost in coaxial cable run. While two antennas, an uplinking antenna 202 and a downlinking antenna 228, are shown, one antenna could be used along with a duplexer which will switch the signal between the uplink and downlink channels.

Also illustrated in FIG. 2 is a GPS antenna 230. A GPS antenna system is often used by cellular communication systems. These systems extract the time signal from the GPS signal. The time signal is then used to synchronize a cellular systems actions. The GPS signal can also be sent via a fiber optic cable

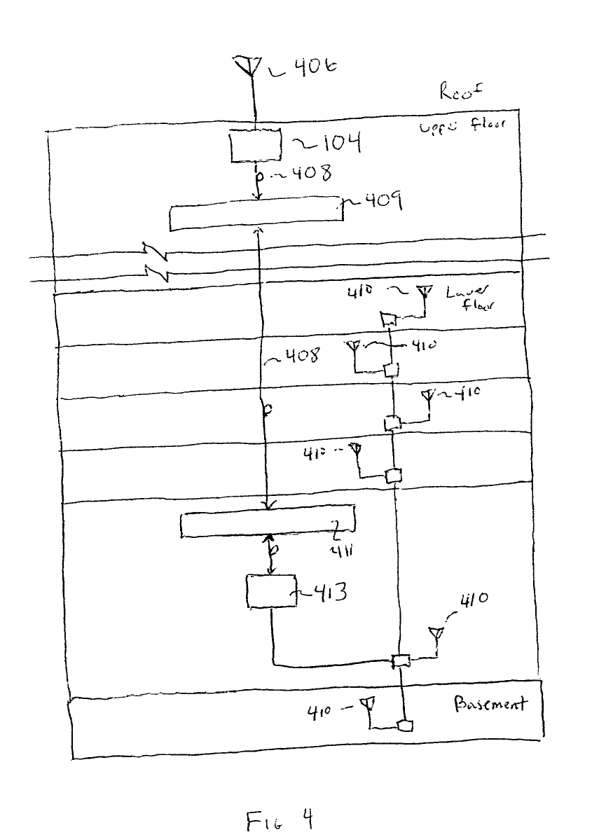

FIG. 3 illustrates a integrated fiber optic antenna system 300. In this embodiment, fiber optic interface box 104 is integrated with antennas 102. This design is useful in new deployments of antenna system and, since it eliminates the coaxial cable connection between the antennas 102 and the fiber optic converter box 104. Antennas 102 comprise both an up-link antenna 202 and a downlink antenna 228. In one embodiment, a single antenna can be used by coupling the antenna to a duplexer, which separate the uplink signal and the downlink signal.

Concerning first the up-link side, up-link antenna 202 is coupled to a band pass filter 206, which isolates the communication band of interest. Coupled to band pass filter 206 is the input to a low noise amplifier 208, which amplifies the signal from the band pass filter 206. The output of the low noise amplifier 208 is then sent to a radio frequency to fiber optic converter 210, which converts the signal from a radio frequency signal to a fiber optic signal. The fiber optic signal is transmitted along fiber optic cable 212.

Considering the downlink side, fiber optic cable 216 is carrying a radio frequency communications signal from a base station or other device. The signal carried by the fiber optic cable 216 is received by a fiber optic to radio frequency converter 218, where the signal is converted to a radio frequency signal. The output of the fiber optic to radio frequency converter 218 is a radio frequency signal, which is sent to an intermediate amplifier 220, which in turn drives a power amplifier 222. The purpose of the amplifier is to increase the gain from the signal and the power of the signal sufficient for broadcasting. The output of the power amplifier is then provided to a band pass filter 224, which filters out the communication signal frequency of interest. The signal is then sent to antenna 228.

Also illustrated in FIG. 3 is a GPS antenna 230. A GPS antenna system is often used in cellular communication systems to extract the time signal from the GPS signal. The time signal is then used to coordination a cellular system's actions. The GPS time signal is sent via fiber optic cable.

FIG. 4 is a schematic illustration of another embodiment of the present invention. Illustrated is a building 402 having a roof 404. Mounted on the roof 404 is an antenna 406. Antenna 406 is coupled to the fiber optic/RF interface box 104 which outputs an optical signal for transmission along a fiber optic cable 408. A splice box receives the fiber optic cable 408, terminates the short run of fiber optic cable 408 and initiates a large run of fiber optic cable 408. After passing through a number of floors, fiber optic cable 408 is received by another fiber optic splice box which terminates the long run and initiates as small run as an output. The output of fiber optic splice box is presented to fiber optic to RF converter. Fiber optic to RF converter converts the optical signal to a radio frequency signal. The radio frequency signal is sent to a plurality of antenna elements 410 located on the various floors of building 402. These antenna elements are operable to receive and transmit signals inside building 402.

Thus, in operation a radio frequency signal is received by antenna 102. The RF signal is supplied to fiber optic/RF interface box 104, which filters, amplifies and converts the signal to a fiber optic signal. The fiber optic signal is routed through the building to the fiber optic/RF converter when it is converted to a RF signal. The RF signal is supplied to antenna elements 410 located on the different floors of the building 402.

Antenna elements 410 also receive RF communications from within the building and routes the RF signal to fiber optic/RF converter 813. This will convert the RF signal to a fiber optic signal for transmission along fiber optic cable to fiber optic/RF interface box which receives the fiber optic signal and converts it back to an RF signal for broadcast by antenna 104. Instead of using a plurality of antenna elements, a base station could be used instead, as illustrated in FIG. 1.

In this embodiment, the individual antenna elements 410 allows for the use of radio frequency communications inside buildings that would normally have poor reception. While this embodiment shows a building, the same techniques could be used for a tunnel or other underground structure as well as a moving vehicle such as a train or ferryboat.

1. An antenna system for receiving radio frequency signals and transmitting radio frequency signals over fiber optic cables comprising:
an antenna for receiving radio frequency transmissions;
an interface box coupled to the antenna for converting a radio frequency signal to a fiber optic signal;
a fiber optic cable coupled to the interface box for transmitting the fiber optic signal;
a fiber optic converter coupled to the interface box by the fiber optic cable and operable to convert the fiber optic signal to the radio frequency signal; and
a communication base station coupled to the fiber optic converter operable to receive the radio frequency signal from the fiber optic converter and to transmit the radio frequency signal.

2. The system of claim 1, wherein the interface box comprises:
a band pass filter for filtering the radio frequency signal;
an amplifier, coupled to the band pass, for amplifying the radio frequency signal; and
a radio frequency to fiber optic converter for converting the amplified signal to an optical signal.

3. The system of claim 1, wherein the base station is a distribution system that distributes the radio frequency signal to a plurality of antenna elements distributed throughout a building.

4. The system of claim 1, further comprising a second interface box located near and coupled to the communication base station, the second interface box operable to receive radio frequency signals from the base station and convert the signal to a fiber optic signal to be transmitted back to an antenna.

5. The system of claim 1, wherein a GPS signal is routed with the fiber optic signal.

6. The system of claim 1, wherein the interface box is integrated with the antenna as a signal antenna unit.

7. The system of claim 6, wherein the single antenna unit includes both an uplink and a downlink path.

8. The system of claim 1, wherein the antenna is located on the roof of a building and the base station is located remotely from the antenna, within the building.

9. The system of claim 7, wherein the downlink path comprises:
a fiber optic to radio frequency converter for converting fiber optic signals to a radio frequency signal;
an amplifier for amplifying the radio frequency signal;
a filter for filtering the radio frequency signal; and
an antenna for broadcasting the radio frequency signal.

10. A communication interface device comprising:
an uplink path operable to receiving a radio frequency signal the uplink path comprising:
a band pass filter operable to filter a radio frequency signal;
a low noise amplifier coupled to the band pass filter for amplifying the radio frequency signal; and
a first radio frequency fiber optic converter operable to convert the amplified radio frequency signal to a fiber optic signal.

11. The device of claim 10, further comprising a second radio frequency to fiber optic converter located remotely from the first radio frequency to fiber optic converter and coupled by a fiber optic cable, the second radio frequency to fiber optic converter operable to convert the fiber optic signal to a radio frequency signal.

12. The device of claim 11, wherein an antenna distribution system is coupled to the second radio frequency to fiber optic converter, the antenna distribution system operable to distribute the radio frequency signal to a plurality of antenna elements distributed throughout a building.

13. The device of claim 10, wherein a GPS signal is sent with the fiber optic signal.

14. The device of claim 10, wherein the uplink path is coupled to an antenna and integrated as a single antenna unit.

15. The device of claim 14, wherein the single antenna unit includes both an uplink and a downlink path.

16. The device of claim 10, wherein the fiber optic converter is located on the roof of a building and the antenna distribution system is located remotely from the radio frequency to fiber optic converter, within the building.

17. The device of claim 11, wherein the second radio frequency to fiber optic converter is coupled to a base station operable to receive the radio frequency signal and transmit the signal.

18. A method for sending a radio frequency signal over a fiber optic cable comprising:
receiving a radio frequency signal at an antenna included as part of an integrated antenna unit;
filtering the radio frequency signal using a filter integrated with the antenna unit;
amplifying the radio frequency signal using an amplifier integrated with the antenna unit;
converting the radio frequency signal to a fiber optic signal using a radio frequency to fiber optic converter integrated with the antenna unit.

19. The method of claim 18, further comprising:
receiving a fiber optic signal at the integrated antenna unit;
converting the fiber optic signal to a radio frequency signal at a fiber optic to radio frequency converter integrated as part of the antenna unit; and
sending the signal over a second antenna.

20. An integrated fiber optic antenna comprising:
an uplink path operable to receive a radio frequency signal, convert it to a fiber optic signal and output it to a fiber optic cable;
a downlink path operable to receive a fiber optic signal, convert it to a radio frequency signal and output it to an antenna.
